(19) United States
(12) Patent Application Publication
(10) Pub. No.: US 2007/0194147 A1
(43) Pub. Date: Aug. 23, 2007

(54) Liquid dispensing device

(75) Inventors: Wim Engelen, Vilvoorde (BE); Wim Maas, KV Someren (NL)

Correspondence Address: SENNIGER POWERS, ONE METROPOLITAN SQUARE, 16TH FLOOR, ST LOUIS, MO, 63102, US

(73) Assignee: MONSANTO EUROPE N.V., Antwerpen (BE)

(21) Appl. No.: 10/599,799

(22) PCT Filed: Feb. 2, 2005
(86) PCT No.: PCT/BE05/00015

§ 371 Date: Oct. 10, 2006

(30) Foreign Application Priority Data
Apr. 15, 2004 (EP) 04447097.9

(51) Int. Cl. B05B 9/01; B05B 9/08; B05B 7/02

(52) U.S. Cl. 239/526; 239/525; 239/530

(57) ABSTRACT

The present invention is related to a battery-operated liquid dispensing device comprising a valve which is operated by the trigger (4), and which comprises a valve body (22) with a resilient dome-shaped portion (24), which closes off the valve by being biased against the valve seat (25). By pulling the trigger, the dome-shaped portion (24) is pushed away from the seat, thereby creating a passage for the liquid to pass to a gear pump (13) and nozzle (5).

### FIELD OF THE INVENTION

The present invention is related to a device for dispensing a liquid by spraying, primarily for household use, for example for spraying water on plants, or for dispensing a detergent or agricultural or horticultural products, including fertilizers, herbicide, insecticide or other chemical products in a liquid formulation.

### STATE OF THE ART

Liquid dispensing devices of the above described type are known from several publications. For example, EP-A-1137493 describes a manually operated device with a squeezable trigger which serves to operate a piston pump, for pumping up liquid from the bottle to which the liquid dispenser is connected.

It is known also to apply electricity to drive these devices. For example, WO-A-0207896 is related to a battery-operated sprayer, installed onto a liquid bottle. The batteries are coupled to an electric motor which drives a gear pump and is activated by pulling the trigger of the device and thereby closing a microswitch. In the latter case, the device is also equipped with a complex venting mechanism, for equalizing the pressure inside and outside of the liquid-containing bottle, prior to pumping up the liquid. However, the venting mechanism is an added complexity and hence cost factor of the structure and it is not always necessary to provide such a mechanism inside the spraying device.

EP-A-731736 for example describes a liquid spraying device which can be incorporated into the recess of a larger container, and which can be connected to the liquid inside this container by a flexible tube. Venting is done by providing a venting hole in the container's closure cap.

Besides the presence of a venting mechanism in the spraying device, WO-A-0207896 describes a check valve placed near the lowest point of the device, for prohibiting re-flow of the liquid into the bottle when the pump is de-activated. The type of valve is difficult to operate and its position is not ideal.

### AIMS OF THE INVENTION

The present invention aims to provide a battery-operated liquid dispensing device usable in combination with a liquid-containing bottle or container, and with improved efficiency of the dispensing mechanism.

### SUMMARY OF THE INVENTION

The invention is related to a device such as described in the appended claims.

### SHORT DESCRIPTION OF THE DRAWINGS

FIG. 1 represents a view of the dispensing device of the invention.

FIG. 2 represents a 3D view of the mechanism inside the housing.

FIG. 3 represents a cut-away view of the mechanism.

FIG. 4 shows a detail of the valve body used in a device of the invention.

FIG. 5 shows a detail of the piston used in a device of the invention.

FIG. 6 shows a rear view of the device of the invention.

### DETAILED DESCRIPTION OF A PREFERRED EMBODIMENT

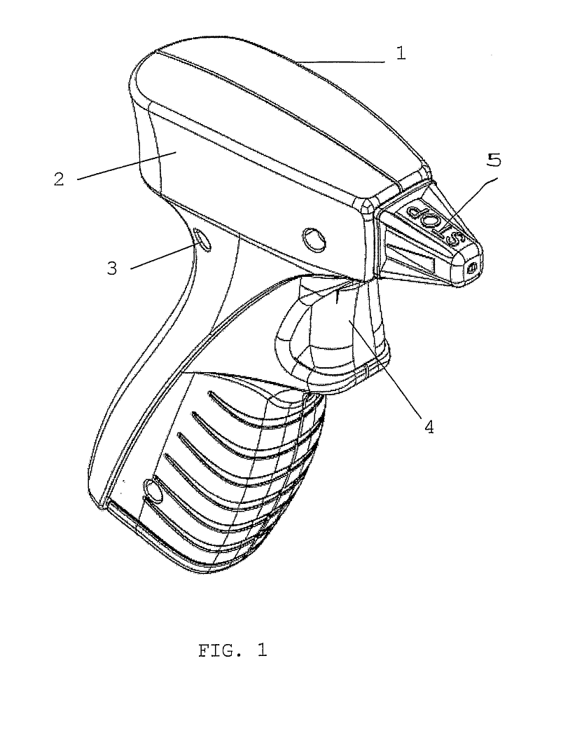

The invention is related to a liquid spraying device as shown in FIG. 1. The device consists of a housing formed of two shell portions 1 and 2, which can be assembled together by screws 3. Other assembling means may be applied. The pumping mechanism is arranged inside this housing and can be activated by a trigger 4. The liquid is sprayed through a nozzle 5. The nozzle may be any kind of conventionally known type of nozzle, used for this purpose.

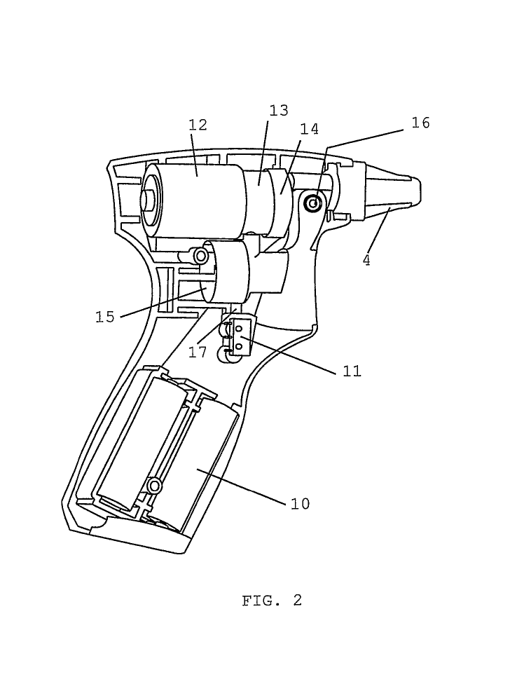

FIG. 2 shows the inside of the spraying device of the invention. The following parts are visible: an electrical power source in the form of a pair of batteries 10, a microswitch 11, an electrical motor 12, coupled to a gear pump 13 with cover 14, a valve housing 15. The trigger 4 pivots around a hinge point 16. When the trigger is pulled back, the switch 11 is activated, turning on the motor and pump. Electrical wires—not shown on the drawings—form the necessary circuit between the batteries, switch and motor, which is activated after the valve is opened.

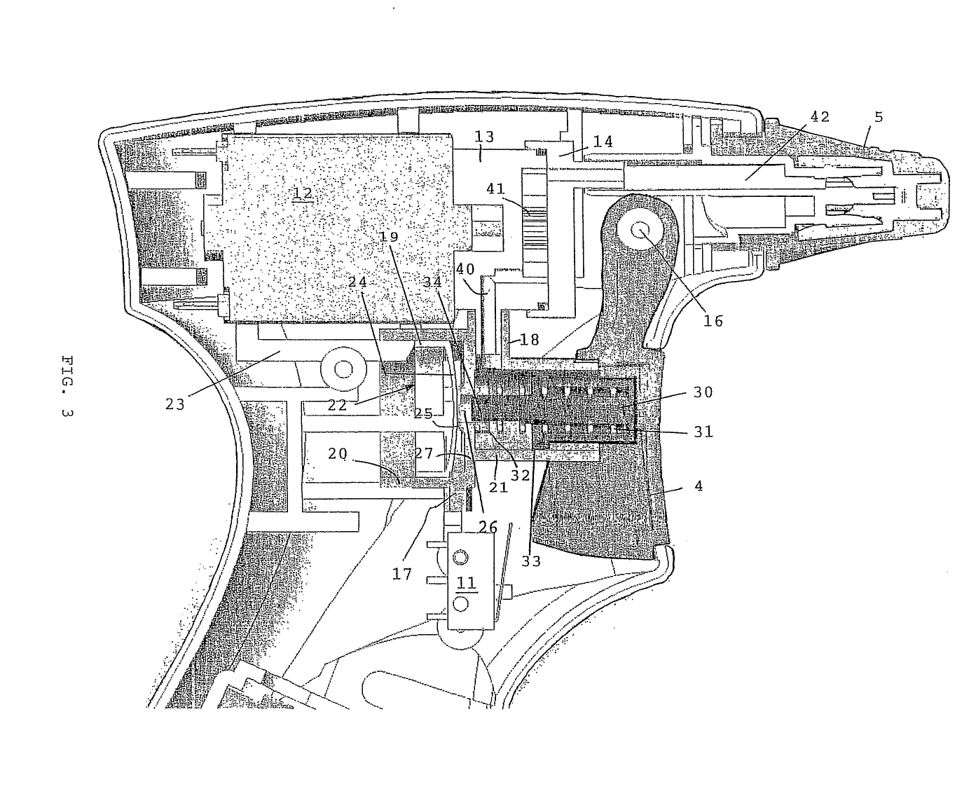

The trigger 4 is equally connected to the valve mechanism, as is shown in FIG. 3. The valve housing 15 is fixed with respect to the motor and pump assembly. The valve housing 15 comprises a first and second cylindrical portion 20 and 21, the second portion 21 having a smaller diameter than the first 20. Both portions are interconnected by central opening 26. The larger-diameter portion 20 comprises an inlet opening 17, to which a flexible tube coming from the liquid container is to be connected. The smaller-diameter portion 21 has an outlet 18, connected to the inlet 40 of the gear pump 13.

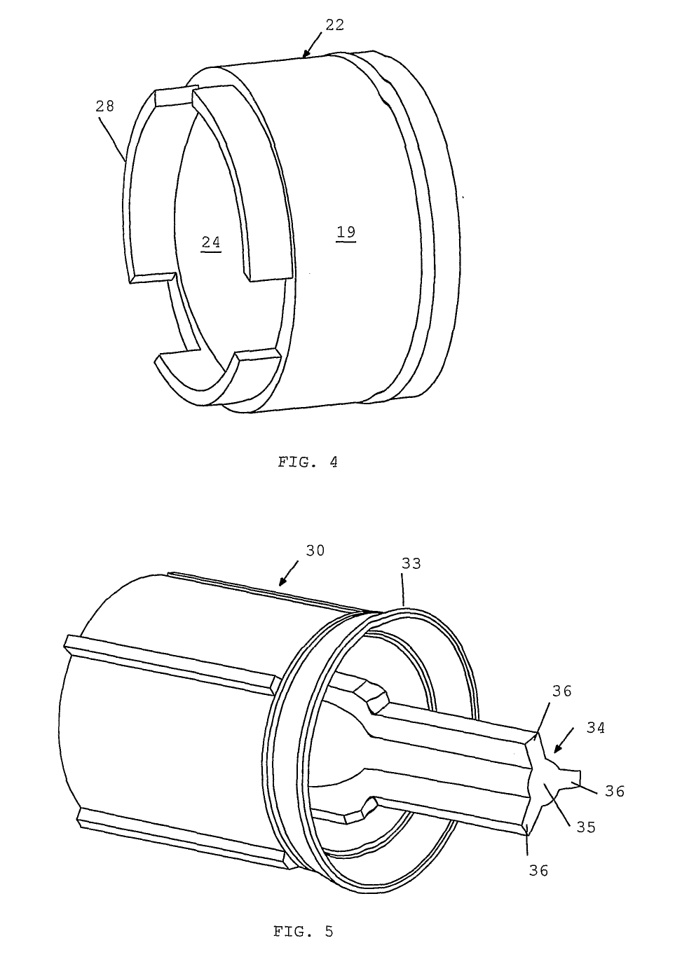

The larger-diameter portion 20 also houses the valve body 22, which comprises a cylindrical portion 19 and a dome-shaped portion 24. The valve body 22 is held in place within the housing 15 by ribs 23, which are an integral part of the shells 1 and 2, or alternatively positioned on motor/pump). The dome-shaped portion 24 is formed of a flexibly resilient material and is biased against the valve seat 25, thereby closing off the opening 26, when the trigger is in the ‘open’ position, as shown in FIG. 3. FIG. 4 shows a detail of the valve body 22. It comprises three axial and curved protrusions 28, surrounding the dome-shaped portion 24, which serve to support the valve body against the dividing wall 27 of the valve housing 15, and center/position it with respect to the piston. Several materials can be used for the valve body 22 and valve housing 15, as long as they provide a certain ratio of stiffness and flexibility.

In the smaller-diameter portion 21 of the valve housing 15, a piston 30 is arranged in a slidable manner. The piston is supported by a helical spring 31, which rests on a seat 32, located opposite the valve seat 25. The spring 31 pushes one end of the piston 30 against the front wall of the trigger 4, so that the spring needs to be compressed when pulling back the trigger. When the trigger is released, the spring pushes it back to its original position.

The piston 30 slides inside the cylindrical portion 21 of the valve housing 15, at least along a section 33, thereby substantially sealing off said portion 21 from the outside environment, so that the liquid is contained on the left hand side of the piston, as seen in the view of FIG. 3.

The opposite end of the piston 30 is formed by a portion of a smaller diameter 34, which is arranged to extend, when the trigger is pulled back, through the opening 26.

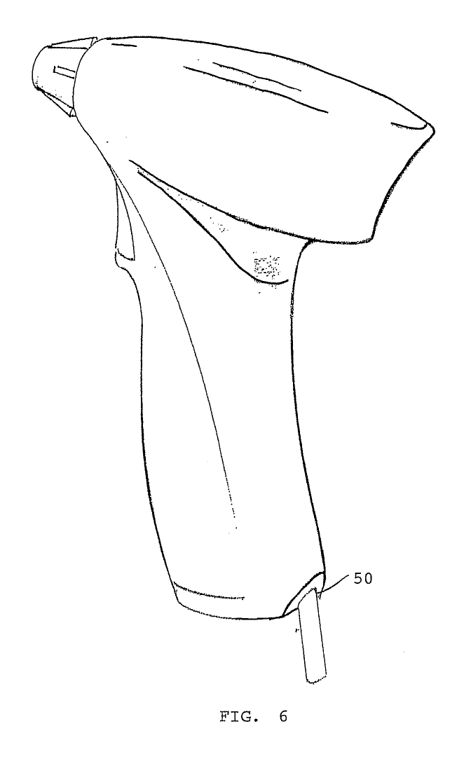

The domed portion 24 is resiliently flexible, so that when the trigger is pulled back, the piston end 34 pushes the domed portion away from the valve seat 25, thereby opening a passage for the liquid to flow from the inlet 17 of the valve housing 15 to the outlet 18. The end portion 34 of the piston has a non-circular section, as shown in the detail of the piston 30 in FIG. 5. This allows the liquid to pass through the opening 26 when the valve dome is pushed back. In the preferred embodiment, the section of the piston end 34 comprises a cylindrical core 35 and three radial protrusions 36.

When the trigger activates the pump, the liquid moves through openings 17, 26 and 18 towards the inlet section 40 of the pump, and the gears 41, after which it is ejected towards the outlet section 42 and the nozzle 5. As soon as the trigger is released, the motor stops, and the dome-shaped portion 24 of the valve resumes its position against the valve seat 25, effectively closing off the passage of the liquid, and preventing flowback of the liquid towards the container. Between spraying actions, the space to the left of the piston remains filled with liquid, so that spraying action can be resumed immediately when the pump is activated, thus avoiding lengthy and power consuming priming of the pump.

This valve arrangement allows a very efficient operation of the spraying device. The valve is located close to the gear pump. Only a small liquid column is left between the valve and the pump, when the spray gun is inactive. Also, the liquid in the hose below the valve stays contained in that hose.

To achieve the best performance, the nozzle of FIG. 3 should be used. The design uses low pressure flow of liquid through the nozzle inner chamber in order to make full use of the pressure provided by pump and motor and saving battery output to ensure longer lifetime. Existing systems use a high pressure nozzle were the liquid needs to be pushed out heavily to get spray.

The device shown in the drawings is closed at the bottom, except for an opening 50 for the passage of a flexible tube coming from the liquid container, see FIG. 6. This is therefore a separate ‘spray gun’, for use preferably in combination with a large container, such as described for example in EP731736. The device of the drawings also has no venting mechanism inside the spray gun itself, which makes it especially useful for applications such as the one of EP731736, where venting of the container is done outside the spray gun. However, the mechanism shown in the drawings could also be applied in a spraying device which is installed on top of a bottle, provided that the pressure equalization between the bottle and the outside environment is done outside the spraying device. Alternatively, a venting mechanism, for example a simple tube between the nozzle and the bottle, may be added to the mechanism shown in the accompanying drawings.

The switch 11 may be operated simultaneously with the opening of the dome valve. Preferably however, first the dome is opened and then the microswitch is pressed. The timing difference is very small but important as the user will likely stop pulling the trigger any further when the motor/pump starts running.

1. Device for dispensing a liquid, said device comprising a housing, equipped with a trigger, and arranged within said housing: an electrical circuit comprising a voltage source, a switch arranged to be activated by pulling back said trigger, a motor, said motor being coupled to a pump, for pumping up said liquid from a container and ejecting said liquid through a nozzle, characterized in that said housing further comprises:
a valve housing comprising a first and second portion, interconnected by an opening, an inlet towards said first portion and an outlet out of said second portion,
a valve body arranged inside said first portion, said body comprising a first portion and a dome-shaped portion integrally moulded with said first portion, said dome-shaped portion being of a resiliently flexible material and placed against a valve seat formed around said opening, thereby closing off said opening, in the non-operative state of the device, and
a piston, in cooperative arrangement with said trigger, said piston being slidably arranged inside said second portion of said valve housing, thereby substantially sealing off said portion from the outside environment, said piston comprising a part which can extend through said opening when the trigger is pulled back, thereby pushing said dome-shaped portion away from the valve seat.

2. The device according to claim 1, wherein said first and second portion of said valve housing and said first portion of said valve body are cylindrical in shape.

3. The device according to claim 1, wherein said piston is supported by a helical spring which rests on a seat, opposite said valve seat, said spring being arranged so that it is compressed when the trigger is pulled back.

4. The device according to claim 1, wherein said housing is formed by two shell parts assembled together.

5. The device according to claim 4, wherein said valve body is held in place inside said valve housing by ribs, which are an integral part of said shell parts.

6. The device according to claim 1, wherein said device is closed at the bottom except for an opening for the passage of a flexible tube which is to be connected to the inlet of said valve housing.

7. The device according to claim 1, wherein said device is open at the bottom and comprises means for being attached on top of a liquid bottle.

8. The device according to claim 1, wherein said pump is a gear pump.
